(19) United States
(12) Patent Application Publication
(10) Pub. No.: US 2023/0107362 A1
(43) Pub. Date: Apr. 6, 2023

(54) METHOD AND APPARATUS FOR SEPARATING SYNTHETIC TURF INFILL MATERIAL

(71) Applicant: Richard Henry COULTON, Chepstow (GB)

(72) Inventor: Richard Henry COULTON, Chepstow (GB)

(21) Appl. No.: 18/078,647

(22) Filed: Dec. 9, 2022

Related U.S. Application Data
(63) Continuation of application No. PCT/GB2021/051441, filed on Jun. 10, 2021.

(30) Foreign Application Priority Data
Jun. 11, 2020 (GB) 2008848.0

(51) Int. Cl. B03B 7/00; B29B 17/02; B03B 5/34; B03B 5/52; B03B 5/62

(52) U.S. Cl. CPC B03B 7/00; B29B 17/02; B03B 5/34; B03B 5/52; B03B 5/62; B29B 2017/0244; B29B 2017/0231; B29B 2017/0224

(57) ABSTRACT

A method of separating infill material (105) of synthetic turf is disclosed. The infill material (105) comprises sand (155), rubber (165) and fibres (135). The method comprises combining the infill material (105) with water (106) to form an infill slurry (110), and separating one or more of the sand (155), rubber (165) and fibres (135) from the infill slurry (105). A hydrocyclone (104) may be used to separate the infill slurry (105) into a fibre slurry (107) and a sand/rubber slurry (111). An separation unit (200) for carrying out the method is also disclosed.

### CROSS-REFERENCE TO RELATED APPLICATIONS

This application is a continuation of, and claims priority to International Application Number PCT/GB2021/051441, filed on Jun. 10, 2021 and entitled METHOD AND APPARATUS FOR SEPARATING SYNTHETIC TURF INFILL MATERIAL, which claims priority to GB Application No. 2008848.0, filed on Jun. 11, 2020. The contents of each are hereby incorporated by references in their entireties.

### FIELD OF THE INVENTION

The present invention concerns separation of infill material of synthetic turf pitches. More particularly, but not exclusively, this invention concerns a method for separating infill material of synthetic turf, the infill material comprising sand, rubber and fibres. The invention also concerns an apparatus for separating sand and rubber from synthetic turf infill material.

### BACKGROUND OF THE INVENTION

Synthetic turf is a surface which is commonly used in applications such as football pitches, hockey pitches, baseball and American football fields, as well as playgrounds, residential and commercial lawns and tennis courts etc. Synthetic turf is primarily used as a substitute for a grass surface. Synthetic turf has many advantages over a grass surface, most notably concerning cost, maintenance, lifespan and all-weather capability. Synthetic turf is a generic term for synthetic grass surfaces, and may be synonymous with, for example, AstroTurf™.

Typically, synthetic turf comprises grass-like fibres (hereafter fibres), which stick out of a backing, and infill material, which forms a soft earth-like layer at the base of the fibres. The infill material comprises sand and rubber, usually in the form of granules. When synthetic turf is new, most of the fibres are held in place, however by the end of the lifecycle of a synthetic turf, some of the fibres will have become dislodged and may be mixed with the infill material.

At the end of the lifecycle of a synthetic turf pitch (typically in the region of 5 to 20 years) it is desirable to reclaim the individual components of the synthetic turf:

namely fibres, sand and rubber. One reason it is desirable to reclaim the individual components is to save on the cost of landfill. Landfill costs for sand, rubber and fibres are especially high, given their weight and environmental properties. It is desirable to reclaim the sand, rubber and fibre as separate components at a high-purity, so that they can be re-used.

One method of recycling synthetic turf is disclosed in WO 2015/059094 (Dennis et al.). WO 2015/059094 describes a process for recycling synthetic turf product which requires that the synthetic turf is transported to a recycling facility, before the synthetic turf is downsized and fed through a number of separation means. In this method, owing to the total weight and volume of the synthetic turf, transportation costs (for transporting the turf to the recycling facility) can be high.

It is an object of the present invention to provide an improved method and apparatus for separating the infill material which are present in synthetic turf products.

The present invention seeks to mitigate the above-mentioned problems. Alternatively or additionally, the present invention seeks to provide an improved method and apparatus for separating infill material of synthetic turf.

### SUMMARY OF THE INVENTION

The present invention provides, according to a first aspect, a method for separating infill material of synthetic turf. The infill material may comprise sand, rubber and fibres. The method may comprise combining (or mixing) the infill material with a liquid, for example with water, to form an infill slurry, and/or separating one or more of the sand, rubber and fibres from the infill slurry.

Advantageously, by mixing the infill material with water, water-based separation processes can be used. For an equivalent volume of material to be separated, water-based separation apparatus is typically lighter and more compact than dry separation equipment. Thus, use of water-based separation may facilitate on-site separation of infill material.

Use of water to separate the sand from the synthetic turf infill may also result in sand that looks clean (in contrast, dry sieved sand separated from SBR (styrene-butadiene rubber, also referred to as black rubber) often appears discoloured) thereby facilitating the reuse of the sand in synthetic turf pitches.

The method may comprise separating the infill slurry into a fibre slurry and a sand/rubber slurry using a first separator. The method may comprise separating the sand/rubber slurry to provide a sand slurry and a rubber slurry using a second separator. The second separator may be of a different type to the first separator. It will be appreciated that each separator may produce additional fractions not mentioned here. For example, the second separator may produce a sand/rubber slurry that is left over after the sand slurry and rubber slurry have been separated off.

It may be that a hydrocyclone is used to separate the infill slurry into fibre slurry and a sand/rubber slurry. Hydrocyclones may be especially useful in this process, as they may allow for the efficient removal of fibre from infill slurry. Additionally or alternatively, a hydrocyclone can achieve this result whilst only occupying a relatively small volume.

It may be that a density separator is used to separate sand and rubber from sand/rubber slurry (i.e. to produce a sand slurry and a rubber slurry). A density separator may be configured to separate two or more fractions using the difference in density between each fraction. A density separator may enable the rubber and sand to be separated from each other effectively. Additionally or alternatively, a density separator may enable the rubber and sand to be separated effectively within a relatively small amount of space.

It may be that water is injected into the sand/rubber slurry after it has left the hydrocyclone and before it has entered the density separator. Water may be added to enable the density separator to work effectively, after water has been removed from the infill slurry in the hydrocyclone overflow.

It may be the majority of the water which enters the hydrocyclone as part of the infill slurry leaves the hydrocyclone in the fibre slurry. The fibre slurry may be the overflow of the hydrocyclone. The sand/rubber slurry may be the underflow of the hydrocyclone.

It may be that the water component of the fibre slurry is recycled for subsequent use in the method. At least part of the water component of the fibre slurry may be added to the sand/rubber slurry, for example immediately upstream of the density separator and/or downstream of the hydrocyclone. At least part of the water component of the fibre slurry may be added in the initial mixing of infill material and water. The method may comprise separating the fibres from the fibre slurry to produce a water stream, for example using a fibre screen to remove the fibres from the slurry. The method may comprise passing the water stream through a water recycling unit (for example via a clarifier) before reuse.

The method may comprise a step of separating trash (also referred to herein as debris) from the infill material, for example using a trash screen. Thus, the method may further comprise the step of feeding the infill material into trash screen to separate debris from the infill material. Debris is commonly present in the infill material and may comprise foreign objects brought onto the synthetic turf during use (on people's shoes for instance), or blown onto the surface. Having a trash screen may enable the efficient removal of debris, and/or improve the efficiency of downstream processes, which do not need to be designed to cope with debris throughput. The trash screen may have a grating-size (a trash screen size) of between 3 mm and 8 mm.

The step of combining the infill material with water to form an infill slurry may comprise mixing the infill material with water in a compartment. This step may comprise passing water and infill material through the trash screen to collect in a compartment, for example a slurry hopper.

It will be appreciated that the steps described above may be carried out simultaneously or sequentially.

It may be that the infill material is first loaded into a feed hopper forming part of a separation apparatus, for example an apparatus in accordance with the second aspect, below. Use of a feed hopper may allow for a controlled input rate of infill material to the rest of the process, thereby ensuring that the correct composition of liquids and solids is fed from the mixing stage.

It may be that the infill material is fed from the feed hopper to the trash screen, for example using a conveyor belt and/or auger.

It may be that the density separator is a fluidised bed separator, a spiral separator, an upflow classifier, and/or a separation jig.

In the case that the density separator is a fluidised bed separator, the method may comprise mixing additional water with the sand/rubber slurry to form a fluidised bed of sand and allowing the rubber to float to the top of the fluidised bed. The method may comprise removing rubber from the top of the fluidised bed. The method may comprise removing sand from a lower region of the fluidised bed.

In the case that the density separator is a spiral separator, the method may comprise the sand/rubber slurry flowing down one or more spiral (or helical) watercourses (also known as troughs) such that, as sand/rubber slurry travels down the spiral, one of the sand and rubber concentrates in the region of the outer end of the width of the watercourse and the other of the sand and rubber concentrates in the region of the inner end of the width of the watercourse. The method may comprise using a first stream from one side of the watercourse and a second stream from the other side of the watercourse, the first stream being one of a sand slurry and a rubber slurry, the second stream being the other of a sand slurry and a rubber slurry. The method may comprise using a third stream from a central region of the watercourse, the third stream being a sand/rubber slurry. The method may comprise recycling the third stream, for example reinjecting it at a point upstream of the density separator, so that is may be separated.

In the case that the density separator is an upflow classifier the method may comprise generating an upward flow of water in a separator compartment containing the sand/rubber slurry. The method may comprising extracting the rubber from a first location in the separator compartment and extracting the sand from a second location in the separator compartment, the first and second locations being at different heights within the separator compartment.

In the case that the density separator is a separation jig, the method may comprise receiving the sand/rubber slurry on a jig bed and generating a pulsing body of water that contacts the sand/rubber slurry on the jig bed to produce a layer of sand and a layer of rubber on the jig bed. The method may comprising removing the sand layer and the rubber layer from the jig bed separately.

The method may comprise a step of removing the infill material from a synthetic turf pitch. The infill material may be removed from the pitch prior to combining with the water, for example prior to be loaded into the feed hopper. The infill material may be removed from the synthetic turf pitch by vacuuming, raking, brushing and/or sweeping. Removal of the infill material from the synthetic turf pitch may be done with rotating brushes.

It may be that the method described above is carried out on site (i.e. at the location where the synthetic turf is installed). Thus one or more, or all, of the steps described for separating infill material of synthetic turf can take place on site. It may be that a separation apparatus (for example the apparatus of the second aspect) for performing the method is transported to the location where the synthetic turf is installed. The equipment may be placed, for the duration of the method being performed, at a location close to the synthetic turf surface (e.g. a synthetic turf pitch), or on the synthetic turf surface. For example, the apparatus for performing the method may be, during use, located within 2 km, for example within 1 km, within 500 meters or within 50 meters of the synthetic turf surface. On site means the general vicinity of the synthetic turf pitch, for instance the grounds of the site where the pitch is located. On site may include the area within a perimeter surrounding the pitch, for example of up to 500 meters from the pitch or at a central location within a large sport facility, for example within 2 km of the pitch. Carrying out the method on site may significantly reduce transportation costs and/or the time taken to complete the separation process.

Carrying out the method on site may allow the sand and/or rubber recovered using the separation process to be reused at that site, for example in any new or refurbished synthetic turf surface. Thus, the method may comprise a step of reusing the sand and/or rubber recovered using the present method as infill in a second synthetic turf surface. Reuse of the sand and/or rubber may reduce the environmental impact of new synthetic turf surfaces.

Alternatively, the apparatus may be located off site. In this embodiment, material is transported to the apparatus by truck. This may be advantageous where there is limited space near the site, and space for the apparatus may be provided at an intermediate distance from the site, of between, for instance, 2 km to 100 km from the site.

The method may comprise a step of reconfiguring the apparatus between a transport configuration and an operative configuration. For example, by moving (for example rotating and/or displacing) one or more of the separators, for example a spiral separator (if present) and/or a hydrocyclone (if present) from a transport configuration to an operation configuration. The step of reconfiguring the apparatus from the operative configuration to the transport configuration may reduce the volume of the apparatus. Reconfiguring the apparatus may facilitate transport, for example by allowing the apparatus to fit inside the footprint of a standard shipping container (for example a 20 ft shipping container).

The method may comprise chemically dosing the water to control levels of bacteria and/or other pathogens that may be present. Dosing may be carried out by a dosing unit, for example forming part of a water recycling unit.

The method may be carried out using an apparatus in accordance with the second aspect of the invention.

According to a second aspect of the invention, there is provided an apparatus for separating sand and rubber from synthetic turf infill material comprising sand, rubber and fibres. The apparatus may comprise a compartment for receiving infill material and mixing the infill material with water to produce an infill slurry. The apparatus may comprise a separator configured to separate one or more of (i) sand, (ii) rubber and/or (iii) fibres from the infill slurry. The apparatus may be suitable for performing the method according to the first aspect of the present invention.

The apparatus may comprise more than one separator, each separator being configured to separate different element(s) from the infill slurry. The apparatus may comprise a first separator configured to separate the infill slurry into a fibre slurry and a sand/rubber slurry. The apparatus may comprise a second separator configured to separate the sand/rubber slurry to provide a sand slurry and a rubber slurry. The apparatus may be configured such that the first separator receives infill slurry from the compartment. The apparatus may be configured such that the second separator receives the sand/rubber slurry from the first separator. The first separator may be located upstream of the second separator. The second separator may be in fluid communication with an outlet of the first separator, in order to receive the sand/rubber slurry therefrom. The apparatus may comprise a water line configured to provide water to the sand/rubber slurry after leaving the first separator.

The apparatus may comprise a hydrocyclone for separating one or more of sand, rubber and fibres from the infill slurry. Thus, the hydrocyclone may be the first separator. The hydrocyclone may separate the infill slurry into two fractions: a fibre slurry and a sand/rubber slurry. The hydrocyclone may be located downstream of the feed and/or slurry hopper (if present) and the trash screen (if present, see below). The hydrocyclone may comprise a chamber having a geometry configured such that infill slurry injected therein via forms a vortex. The hydrocyclone may comprise an inlet via which infill slurry from the compartment enters the hydrocyclone. The hydrocyclone may comprise a first (overflow) outlet and a second (underflow) outlet. The fibre slurry may exit the hydrocyclone via the first outlet and the sand/rubber slurry may exit the hydrocyclone via the second outlet. The first and second outlets may be spaced apart along the longitudinal axis of the hydrocyclone. In use, the first outlet may be located above the second outlet. The chamber may comprise a cylindrical section into which liquid is fed tangentially via the inlet. The chamber may comprise a cone extending from an end of the cylindrical section. It may be that, in use, the first outlet is located at the top of the cylindrical section and the second outlet is located at the bottom of the cylindrical section. Separating the fibre and sand/rubber slurry using a hydrocyclone has been found to enable an especially compact apparatus to be used.

The apparatus may comprise a (wet) density separator for separating the sand/rubber slurry to provide a sand slurry and a rubber slurry. Thus, the density separator may be the second separator. Separating the sand and rubber on density using a separation process including water has been found to enable an especially compact apparatus to be used.

The density separator may be a fluidised bed separator, a spiral separator, an upflow classifier, and/or a separation jig.

A fluidised bed separator may comprise a separator compartment. The separator compartment may comprise a first outlet in the region of the top of the tank and a second outlet located in a lower region of the tank, for example in the region of the bottom of the tank. The separator compartment may be configured to receive the sand/rubber slurry. The separator compartment may be configured to receive water, for example via a water inlet connected to a water recycling unit. In use, sand/rubber slurry is received in the separator compartment and mixed with water to form a fluidised bed of sand. Over time, rubber floats to the top of the sand bed and may be taken off via the first outlet. The separator compartment may comprise a plurality of water inlets spaced apart across the bottom of the tank. The separator compartment may comprise a mixer to mix the sand/rubber slurry and water. The separator compartment may comprise one or more scrapers mounted for movement to remove the rubber that accumulates at the top of bed when the separator is in use. A fluidised bed may be an compact way of separating sand and rubber from the sand/rubber slurry. A fluidised bed may be particularly useful when the difference in density between the sand and rubber is greater than 1.2 g/cm3, for example when the rubber in the infill material is black rubber (SBR).

The spiral separator may comprise one or more, for example two, spiral (or helical) watercourses. In use, the longitudinal axis of each spiral may be substantially vertical. Thus, the spiral separator may be a vertical spiral separator. Each watercourse may comprise a flow gallery or trough along which the sand/rubber slurry can flow. The geometry of the helical watercourse is such that an initially homogenous distribution of sand and rubber across the width of the watercourse changes with distance along the watercourse to have the sand concentrated on one side and the rubber concentrated on the other side. The spiral separator may comprise a first outlet via which material from one side of the watercourse exits the classifier. For example, the first outlet may receive a sand slurry from the inner side of the watercourse. The spiral separator may comprise a second outlet via which material from the other side of the watercourse exits the classifier. For example, the second outlet may receive a rubber slurry from the outer side of the watercourse. The spiral separator may comprise a third outlet via which material from a central region of the watercourse exits the classifier. Such material is typically a mix of sand and rubber and may be recirculated to the top of the spiral separator to be separated again. The spiral separator may comprise a splitter configured to direct flow across the watercourse to the various different outlets. A spiral separator may be a particularly compact and/or effective way of separating the sand and rubber from the sand/rubber slurry. A spiral separator may be particularly useful in the case that the density of the rubber is too high for the rubber to float on the fluidised bed of an upflow classifier, thus using a spiral separator may increase the range of infill materials with which the present method may be used.

The separation jig may comprise a jig bed, for example a screen, configured to receive the sand/rubber slurry and retain the sand and rubber. The separation jig may comprise a pulse generator configured to produce a pulsing body of water when provided with a supply of water. The jig bed and pulse generator may be arranged such that, in use, the pulsing body of water contacts the sand and rubber on the jig bed. In use, the repeated action of the pulsing body of water on the sand and rubber may cause the sand and rubber to settle on the bed in layers of different density. The separation jig may comprise a first outlet via which sand exits the jig and a second outlet via which rubber exits the jig.

The upflow classifier may comprise an upflow compartment configured to receive the sand/rubber slurry. The upflow classifier may comprise a flow generator configured to provide an upward flow of water within the upflow compartment. The upflow classifier may comprise an auger located partially within the upflow compartment for removing higher density elements (e.g. one of sand and rubber) that have settled to a lower region of the compartment. Alternatively, the upflow classifier may comprise an outlet in a bottom region of the upflow compartment via which higher density elements can leave the compartment. The upflow classifier may comprise a flow control valve configured to control the flow through the outlet, for example in response to changes in pressure within the upflow compartment. The upflow classifier may comprise an outlet, for example a weir via which a mixture comprising water and lower density elements (e.g. the other of sand and rubber) can exit the upflow compartment. The upflow classifier may comprise a screen, the mixture of water and lower density passing through or over the screen such that the screen can capture the lower density elements.

The apparatus may comprise a trash screen configured to separate debris from the infill material. The apparatus may be arranged such that infill material passes through the trash screen and into the compartment. The apparatus may comprise a trash receptacle (for example a bag or container) configured to receive trash from the trash screen. Trash may be discharged from the side of the trash screen to the trash receptacle. The trash screen may be inclined to facilitate the movement of trash along the trash screen to the trash receptacle. The apparatus may comprise a motor, for example two motors, configured to vibrate the trash screen. Vibration of the screen may encourage the trash to move along the screen. The apparatus may comprise a water line configured to provide water to the compartment in which the infill material is received, for example by providing a flow of water that goes through the trash screen and into the compartment with the infill material. Thus, water and infill material may pass through the trash screen and combine in the compartment to produce the infill slurry.

The apparatus may comprise a slurry hopper. The slurry hopper may comprise the compartment in which the water and infill material mix. The slurry hopper may be located beneath the trash screen.

The apparatus may be arranged so that, in use, sand and rubber is fed from the hydrocyclone to the density separator.

The apparatus may comprise one or more pumps to circulate the various slurries and water between the different elements of the apparatus.

The apparatus may comprise a power generator for generating the electricity necessary for the apparatus to function. Provision of such a power generator may facilitate the use of the apparatus on site.

The apparatus may comprise a main water inlet for connection to a water supply.

The apparatus of the invention as described above may be provided in a single unit. For example, wherein the elements of the apparatus described above are mounted on a common platform and/or framework. Providing the apparatus in a single unit may facilitate transport of the equipment to the site. The footprint of the unit may be contained within the footprint of a standard 20 ft shipping container. The unit may have a length of 20 ft (or less) and a width of 8 ft (or less). The unit may have a height of 9 ft 6 inches, for example 8 ft 6 inches (or less).

The apparatus may be configured for movement between a transport configuration and an operation configuration. In the case that the apparatus comprises a spiral separator, it may be that the longitudinal axis of the spiral is substantially horizontal in the transport configuration and substantially vertical in the operation configuration. In the case that the apparatus comprises a hydrocyclone, it may be that longitudinal axis of the hydrocyclone is substantially horizontal in the transport configuration and substantially vertical in the operation configuration. The hydrocyclone may be mounted on the spiral separator so that in the operation configuration the hydrocyclone is atop the spiral separator. The spiral separator and/or hydrocyclone may be mounted for movement, for example pivotal movement, between the transport and operation configurations. Alternatively, the spiral separator and/or hydrocyclone may be demounted and remounted to reconfigure the apparatus between the transport and operation configurations.

The apparatus may comprise a water recycling unit configured to supply water for use in the separation process. The water recycling unit may be provided as a separate unit to the (main) unit described above. In use, the water recycling unit may be connected to the main unit, for example via the main water inlet. The footprint of the water recycling unit may be contained within the footprint of a standard 20 ft shipping container. The unit may have a length of 20 ft (or less) and a width of 8 ft (or less). The unit may have a height of 9 ft 6 inches, for example 8 ft 6 inches (or less).

The apparatus may comprise a sand drying unit configured to dry the sand separated by the separation unit. The sand drying unit may be provided as a separate unit to the (main) unit described above. The footprint of the sand drying unit may be contained within the footprint of a standard 20 ft shipping container. The unit may have a length of 20 ft (or less) and a width of 8 ft (or less). The unit may have a height of 9 ft 6 inches, for example 8 ft 6 inches (or less).

The apparatus may be configured such that water removed from the infill slurry, fibre slurry, sand/rubber slurry, sand slurry and/or rubber slurry is returned to the water recycling unit. The water recycling unit may be configured to store and/or treat the water so that it can be reused in the separation process. The water recycling unit may comprise a clarifier. The water recycling unit may comprise a storage compartment for storing water.

Infill material may comprise sand, rubber and fibres and, optionally, debris. The infill material may predominantly comprise sand and rubber, and may further comprise small amounts of fibre (synthetic fibre) and even smaller amounts of debris. It is likely that during use of the synthetic turf, debris will have been brought onto the surface which may then also form part of the infill material, which leads to sand, rubber and fibres making up less than 100% of the infill material in practice, with the remaining volume/weight of infill material being made up of debris. Sand and rubber may make up the majority of the infill material by volume and/or by weight. Sand and rubber may make up over 80%, for example over 90%, for example over 95%, for example over 98% of the infill material by volume and/or by weight. The rubber of the infill material may be granular rubber. The rubber may be crumbed rubber, for example crumbed rubber made from used tyres. The rubber may be EPDM rubber (ethylene propylene diene monomer rubber, also referred to as green rubber), and/or SBR rubber (styrene-butadiene rubber, also referred to as black rubber). The rubber may be TPE (thermoplastic elastomer), Cork, EPDM variations, PE (polyethylene) or TVP (thermoplastic vulcanised rubber). The sand of the infill material is granular. The fibre of the infill material is commonly a plastic-based fibre. The fibre may be a plastic fibre. The fibre may be a synthetic fibre. The term “synthetic fibre” may be used herein to describe the fibre. The fibre may be a strand, sinew or thread, for example having a blade-of-grass-like appearance. The fibre may be made from one or more plastics, for example two or three plastics. The fibres may be damaged and may therefore be small parts of fibres.

Further information on the properties of some example infill materials may be found in Table 1, below.

TABLE 1
Properties of example infill materials

| | Particle Size | Density | Bulk Density |
|---|---|---|---|
| Sand | 0.2-0.8 mm | 2.65 g/cm3 | 1600 g/l |
| EPDM | 0.5-2.0 mm | 1.6 g/cm3 | 650 g/l |
| SBR | 0.5-2.0 mm | 1.2 g/cm3 | 400 g/l |
| Other: | | | |
| Coated SBR | 0.5-2.0 mm | 1.3 g/cm3 | 500 g/l |
| EPDM Fibre | | 1.6 g/cm3 | 500 g/l |
| Cork | 0.5-2.0 mm | 0.2 g/cm3 | |
| RC-EPDM | 0.8-2.8 mm | | 600 g/l |
| Hybrid EPDM | 0.5-2.7 mm | 1.4 g/cm3 | 450 g/l |
| TPE | 0.5-1.5 mm | 0.6 g/cm3 | 500 g/l |

The trash screen may have a trash screen size. The trash screen may allow granules smaller than the trash screen size to pass through, but entrain larger particles. The trash screen size may be between 3 mm and 8 mm, for example between 4 mm and 7 mm, for example 5 mm.

A slurry, as used herein, should be understood to mean a mixture of solids and water. For example, a rubber slurry is a mixture of rubber and water, a fibre slurry is a mixture of synthetic fibre and water, a sand slurry is a mixture of sand and water, infill slurry is a mixture of infill material and water, and sand/rubber slurry is a mixture of sand and rubber and water.

Following separation, the sand and rubber may be almost pure, or have some small contaminants present. For example, the sand which is separated and collected may have a purity above 95%, or may have a purity above 98%. The rubber which is separated and collected may have a purity above 95%, or may have a purity above 98%. Where purity is mentioned as a percentage, it may be either by weight or volume.

The apparatus may comprise a sand screen configured to separate sand from the sand slurry (i.e. to separate sand from water). The sand screen may be a dewatering screen. The apparatus may comprise a water-collection compartment in which water is collected after passage through the sand screen. In use, the water-collection compartment may be connected to the water treatment unit. The apparatus may comprise a sand receptacle (for example a bag or container) for collecting sand following separation. The sand receptacle may be configured to receive sand from the sand screen. The apparatus may comprise a motor, for example two motors, configured to vibrate the screen. The sand screen may be inclined, for example towards the sand receptacle.

The apparatus may comprise a rubber screen configured to separate rubber from the rubber slurry (i.e. to separate rubber from water). The rubber screen may be a dewatering screen. The apparatus may comprise a water-collection compartment in which water is collected after passage through the rubber screen. In use, the water-collection compartment may be connected to the water recycling unit. The apparatus may comprise a rubber receptacle (for example a bag or container) for collecting rubber following separation. The rubber receptacle may be configured to receive rubber from the rubber screen. The apparatus may comprise a motor, for example two motors, configured to vibrate the screen. The rubber screen may be inclined, for example towards the rubber receptacle.

The apparatus may comprise a fibre screen configured to separate fibre from the fibre slurry (i.e. to separate fibre from water). The fibre screen may be a dewatering screen. The apparatus may comprise a water-collection compartment in which water is collected after passage through the fibre screen. In use, the water-collection compartment may be connected to the water recycling unit. The apparatus may comprise a fibre receptacle for collecting fibres following separation. The fibre receptacle may be configured to receive fibre from the fibre screen. The apparatus may comprise a motor, for example two motors, configured to vibrate the screen. The fibre screen may be inclined, for example towards the fibre receptacle.

Each screen may be connected to the same or separate water-collection compartment. The apparatus may comprise one or more water-collection hoppers each comprising a water-collection compartment.

The apparatus may configured to process between 0.5 m³/hour and 40 m³/hour of infill material, for example between 0.5 m³/hour and 30 m³/hour of infill material, for example between 0.5 m³/hour and 20 m³/hour of infill material, for example between 0.5 m³/hour and 10 m³/hour of infill material, for example between 0.5 m³/hour and 2 m³/hour of infill material, for example between 0.8 and 1.5 m³/hour of infill material. It may be that the majority, for example more than 90%, for example around 95% of the infill material by volume and/or weight is sand and rubber.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a process flow diagram of an example method according to the invention.

FIG. 2 shows a schematic side view of the separation unit according to a first example embodiment of the invention, when in a stowed configuration;

FIG. 3 shows a side view of the separation unit of FIG. 2, when in an operational configuration;

FIG. 4 shows a plan view of the separation unit of FIG. 2, when in the stowed configuration;

FIG. 5 shows an end view of the separation unit of FIG. 2, when in the stowed configuration;

FIG. 6 shows a side view of the separation unit of FIG. 2, when in the operational configuration;

FIG. 7 shows a side end view of the separation unit of FIG. 2, when in the operational configuration;

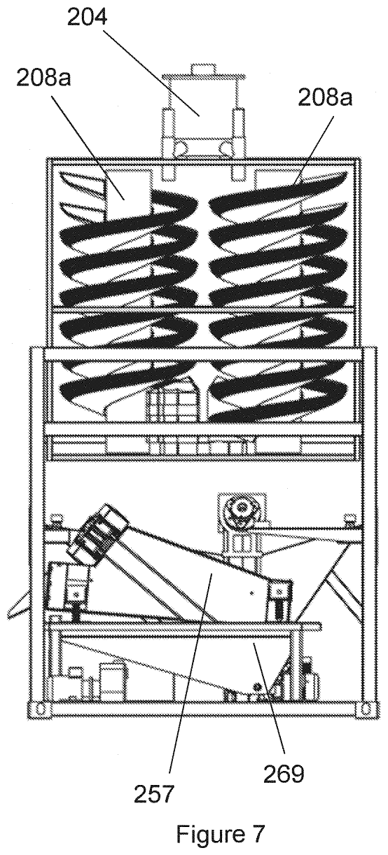

FIG. 8 shows a plan view of the separation unit of FIG. 2, when in the operational configuration;

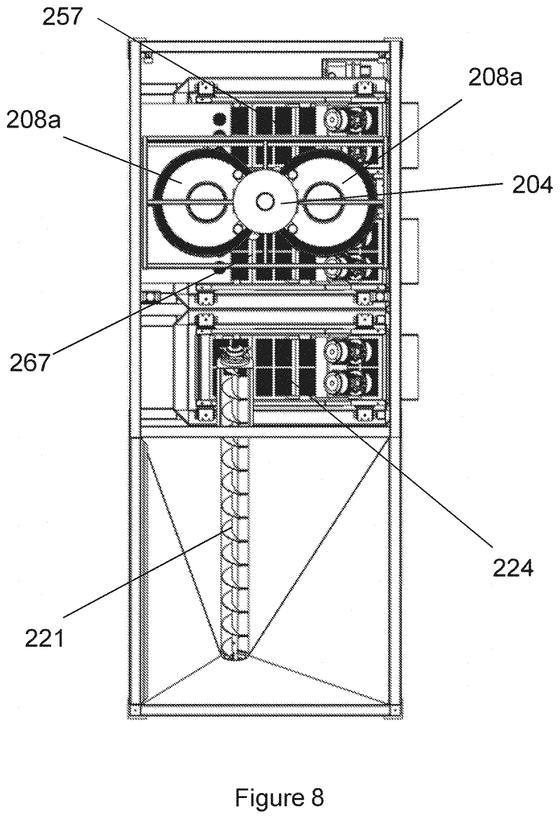

### DETAILED DESCRIPTION

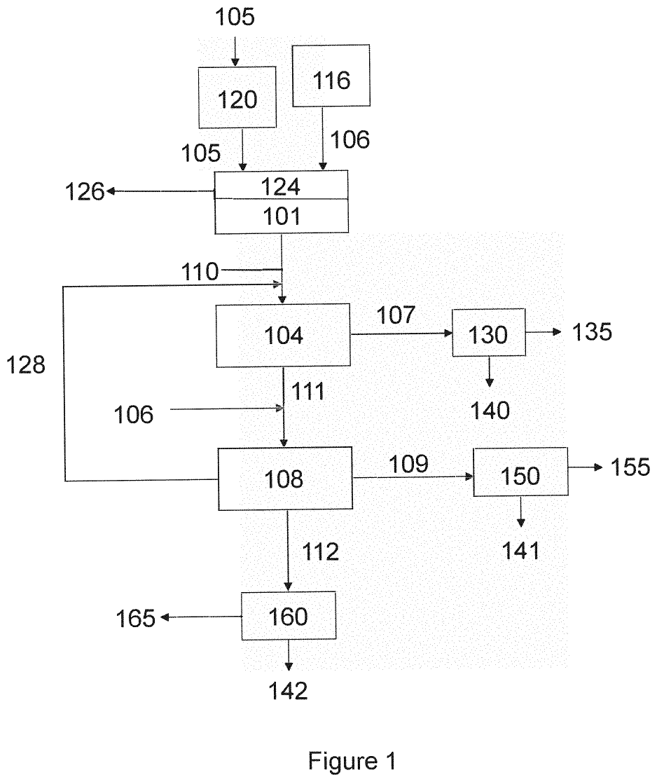

FIG. 1 shows an example system for separating synthetic turf infill material in accordance with an embodiment of the present invention. Infill material 105 is fed from a hopper 120 into a tank 101, in which the infill material 105 mixes with water 106. Infill material 105 may be released into the tank at a constant rate, from the hopper 120.

Optionally, infill material 105 is fed from the hopper 120 via trash screen 124, which separates trash 126 from the infill material 105. The trash screen prevents trash (e.g. debris, which is not sand, rubber or synthetic grass) from passing into the tank 101. Trash is discharged from the screen 124 to a bag or container (not shown) or the like, located adjacent the trash screen. In some embodiments the trash screen prevents particles larger than 5 mm from passing through the screen. Trash 126 is discharged from the top side of the trash screen 124. In other embodiments, different methods of removing debris from the infill material prior to mixing may be employed.

Optionally, the method takes place at the site of a synthetic turf surface and includes steps of transporting the apparatus to the site and removing the infill material from the synthetic turf surface (not shown).

Optionally, water 106 is fed into the trash screen 124 from a water recycling unit 116 at the same time as infill material 105 is fed to the trash screen 124, which helps to pass the infill material 105 through the trash screen 124 and separate the infill material 105 from the trash 126. The water 106 and the infill material 105 mix in the tank 101 to form infill slurry 110. In some embodiments the tank 101 is a sump of the trash screen, in other embodiments it may be a separate compartment or part of a hopper. The infill slurry 110 is then pumped from the tank 101 to a hydrocyclone 104. Hydrocyclones are usually used for separating water from heavier particles. In this usage, the synthetic fibres which make up a part of the infill slurry 110 also leave the hydrocyclone in the overflow, with the water. Thus, the hydrocyclone 104 is used to separate synthetic fibres and water (fibre slurry 107) from the infill slurry 110. The synthetic fibre slurry 107 is fed to a fibre screen 130, which separates the synthetic fibres 135 from the water 140. The heavy component which leaves the hydrocyclone in the underflow is a sand and rubber slurry (sand/rubber slurry 111), comprising sand, rubber and water. Water 106 can be injected or otherwise combined with the sand/rubber slurry 111 to ensure the optimum feed consistency of the sand/rubber slurry 111 which is fed to a spiral separator 108. The spiral separator 108 splits sand/rubber slurry 111 into sand slurry 109, rubber slurry 112 and a left-over sand/rubber slurry 128. The sand slurry 109 is fed to a sand screen 150, which separates the sand 155 from the water 141. The rubber slurry 112 is fed to a rubber screen 160 which separates the rubber 165 from the water 142. In the embodiment of FIG. 1 the sand/rubber slurry 128 is recirculated to mix with infill slurry 110 upstream of the hydrocyclone 104. In the same or yet further embodiments, the sand/rubber slurry may, additionally or alternatively be returned into the infill slurry 110 in the tank 101 and/or into the sand/rubber slurry 111. The water 141, 142, 140, which passes through the sand screen 150, rubber screen 160 and synthetic fibre screen 130 is collected below the screens in a hopper or container or sump or the like, and pumped to the separate water recycling unit 116 which comprises a clarifier (not shown) and water storage compartment (not shown), for example a bund or a tank, or water may be fed back into the process at the trash screen and/or into the sand/rubber slurry. The water 141, 142, 140 is treated in the clarifier, and is then stored in the water storage compartment. Water 106 pumped from the water storage compartment of the water recycling unit 116 can be used wherever water is introduced into the process.

The sand 155, rubber 165, synthetic fibres 135 and trash 126 which are separated in the method may be collected separately by any suitable means, for example in piles, tanks, hoppers, containers, bags or construction sacks. Synthetic fibre 135 and trash 126 may be handled together for disposal. Sand 155 and rubber 165 may be reused in any new synthetic fibre surface laid at the site.

Optionally, a sand drying unit (not shown) configured to dry the sand 155 separated by the separation unit is also provided.

Mixing the infill material 105 with water 106, facilitates the use of wet separation processes (separation processes which include water). For an equivalent volume of infill material, wet separation processes can be carried out using more compact and lighter equipment than dry separation processes (where water is not used) such as the one disclosed in WO 2015/059094. Accordingly the system in accordance with the present invention may reduce the overall size of the equipment needed to separate the infill material 105 from one another. Further, the reduction in size may facilitate the separation of infill material on site.

Additionally or alternatively, use of wet separation processes may lead to improved separation for example sand may appear clear following wet separation in contrast to prior art dry separation processes.

Additionally or alternatively, by having a water recycling capability, the amount of water required for the separation may be reduced, as, after start-up, the only fresh water that needs to be added to the process is water which replaces that lost through being present with the sand 155, rubber 165, synthetic fibre 135 and debris 126 which exits the system.

While the system described above uses a spiral separator as a density separator, other types of density separators may be used, for example fluidized bed separators, upflow classifiers and/or separations jigs.

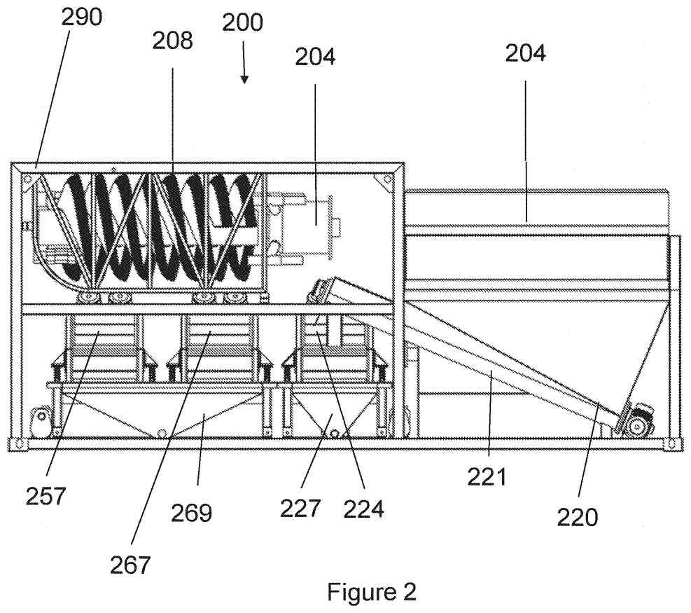

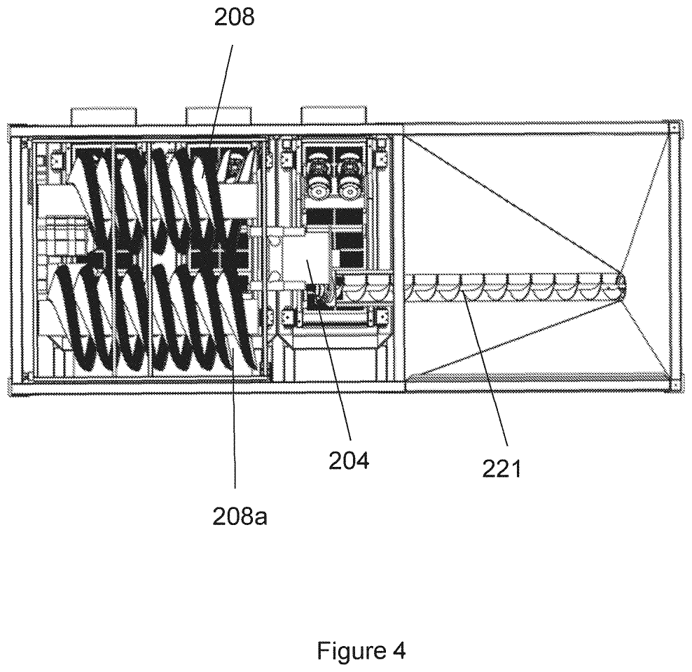

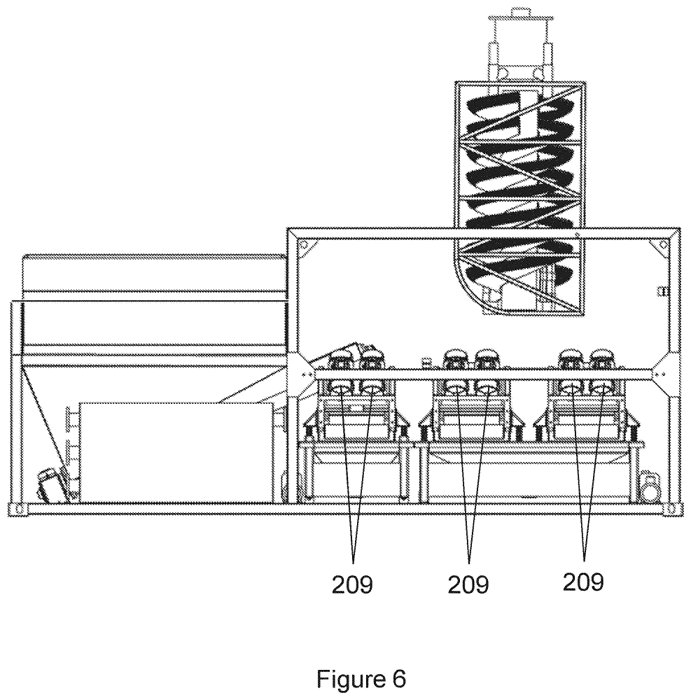

In the description of FIGS. 2 to 6, reference numerals correspond to those of similar elements in FIG. 1 but incremented by one hundred, for example spiral separator 108 of FIG. 1 corresponds to spiral separator 208.

FIGS. 2 to 6 show an example separation unit 200 in accordance with an embodiment of the invention. Arranged along one of the long sides of the unit are (in order): A water-collection hopper 269, and a slurry hopper 227. A feed hopper 220 is located at one end of the unit 200, adjacent the slurry hopper 227. The feed hopper 220 is located at the opposite end of the unit to the water-collection hopper 269. A sand screen 257 is located above and toward one end of the water-collection hopper 269. A rubber screen 267 is located above and to the other end of the water-collection hopper 269 and a trash screen 224 is located above the slurry hopper 227. It will be appreciated that in other embodiments the hoppers and screens may be laid out in other, different, configurations or that the hoppers may be replaced with other appropriate containers. Each of the screens 257, 267 and 224 is inclined and vibrated by two motors 209 mounted atop the screen. A bag or sack (not shown) is located adjacent the screen to collect particles retained by the screen

A dosing unit (not shown) is located within a water recycling unit (not shown) to chemically dose the water to prevent bacterial growth and/or reduce levels of pathogens in the water.

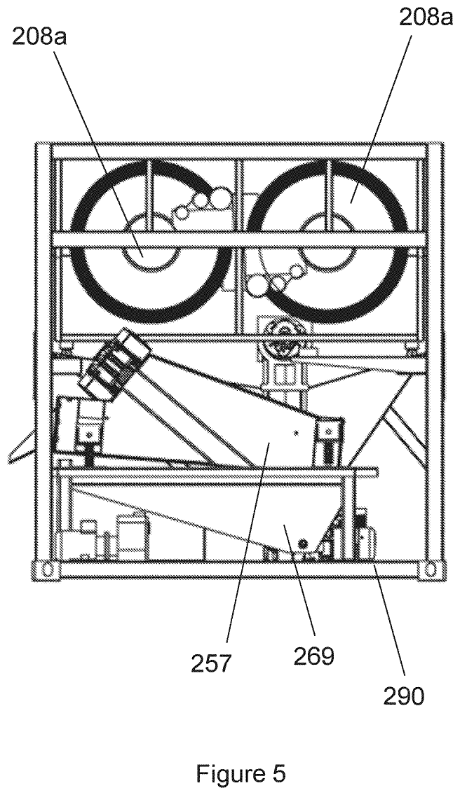

In FIG. 2, a spiral separator 208 is arranged in a stowed position (suitable for transport or storage) with the longitudinal axis of the spiral separator 208 extending horizontally along the length of the unit above the water-collection hopper 269 and slurry hopper 227. The spiral separator 208 comprises two helical troughs 208a (see FIG. 5) extending along the longitudinal axis of the spiral separator 208. A hydrocyclone and flow distribution chamber, hereafter referred to as hydrocyclone 204, is connected to the distal end of the spiral separator 208 (the end located above the slurry hopper 227 in FIG. 2).

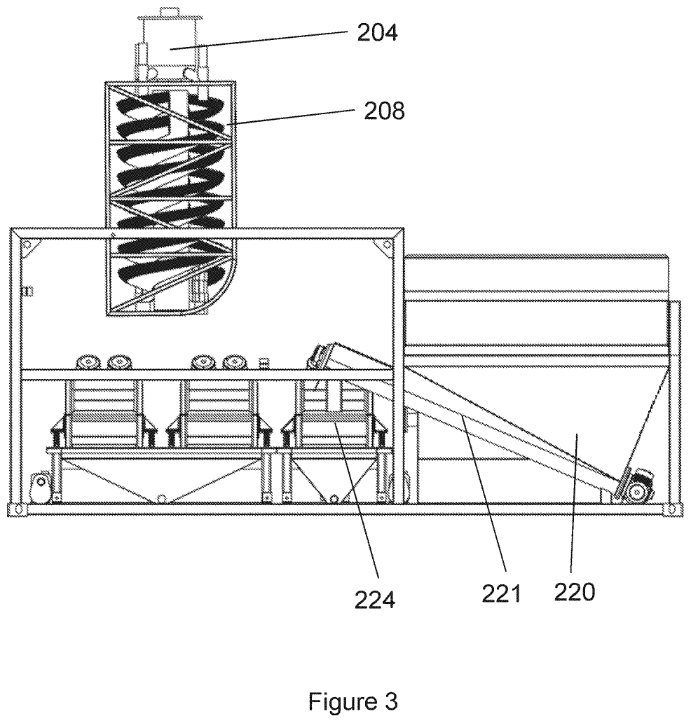

In FIG. 3, the spiral separator 208 is arranged in an operational position, with the longitudinal axis of the spiral separator 208 extending vertically upwards. In the operative position the spiral separator 208 is located above the water-collection hopper 269.

The feed-hopper 220 has a conveyor belt/auger 221 which extends between a position adjacent the short edge of the unit and the bottom of the feed hopper 220 to a position above the trash screen 224 and slurry hopper 227. A feed line (not shown) extends from the slurry hopper 227 to the hydrocyclone 204. When shown in the operative position of FIG. 3 the bottom of the hydrocyclone 204 is connected to the top of the spiral separator 208. A first water line (not shown) provides water to the trash screen 224, for example from a separate water recycling unit (not shown). A second water line (not shown) provides water from the water recycling unit to a point between the hydrocyclone 204 and the spiral separator 208. A return line (not shown) connects the hydrocyclone overflow to a water recycling unit, optionally via a fibre screen (not shown). The water recycling unit is contained in a separate unit, and is connected to the separation unit 200 to provide water thereto. Output lines (not shown) connect the bottom of the spiral separator 208 to each of the sand screen 257 and the rubber screen 267.

The present embodiment comprises two separators: a hydrocyclone 204 and a spiral separator 208. In other embodiments, a different density separator may be used in place of the spiral separator 208, for example a fluidised bed separator, upflow classifier or a hydraulic pulsating separation jig. In the same or yet further embodiments, the hydrocyclone 204 may be absent.

The arrangement shown in FIGS. 2 to 6 also includes various pumps and piping (not shown for the sake of clarity) which pump/transport the slurries/water in the system.

The separation unit 200 can fit into the footprint of a standard 20 ft shipping container. In the transport configuration (shown in FIG. 2) the separation unit can fit within the dimensions of a standard 20 ft shipping container (including the height). In the operation configuration (shown in FIG. 3) the spiral separator 208 and hydrocyclone 204 extend above the height of a standard shipping container.

In use, infill material is removed from the synthetic turf surface and deposited in the feed hopper 220 of the separation unit 200 located at the site of the synthetic turf surface. Debris is removed from the infill material as it passes through the trash screen 224 and the infill material mixes with water to produce infill slurry which is collected in slurry hopper 227. Trash captured by the trash screen 224 is collected separately. The infill slurry from hopper 227 is pumped to the top of the hydrocyclone 204 where it is separated into a fibre slurry and sand/rubber slurry. The sand/rubber slurry passes from the bottom of the hydrocyclone 204 to the top of the spiral separator 208. The fibre slurry passes from the top of the hydrocyclone 204 to the water recycling unit, via a fibre screen (not shown). Optionally, water is mixed with the sand/rubber slurry between the bottom of the hydrocyclone 204 and the top of the spiral separator 208. The sand/rubber slurry passes through the spiral separator which separates the sand/rubber slurry into (i) sand slurry, (ii) rubber slurry and (iii) sand/rubber slurry. The sand slurry flows from the spiral separator 208 to the sand screen 257 where sand is separated from the sand slurry and deposited in a pile or receptacle. Water passes through the sand screen 257 to water-collection hopper 269. The rubber slurry flows from the spiral separator 208 to the rubber screen 267 where rubber is separated from the rubber slurry and deposited in a pile or receptacle. Water passes through the rubber screen 267 to water-collection hopper 269. Thus, the water-collection hopper 269 collects water which has been screened for sand and rubber respectively. Water is pumped from the water-collection hopper 269 to the water recycling unit and/or the water is recirculated back onto the trash screen/into the rubber/sand slurry. Thus, apparatus in accordance with the present example embodiment may effectively separate sand, rubber and fibre from infill material. Additionally or alternatively, apparatus in accordance with the present invention may allow separation to take place on site, thereby reducing transportation costs and/or allowing for reuse of the infill materials in any new synthetic turf surface at that site. Additionally or alternatively, recirculation and recycling of water within the apparatus may reduce the amount of water used during the separation process.

While a hydrocyclone and spiral separator have been described above it will be appreciated that different forms of density separator may be used, including fluidized bed separators, upflow clarifiers and separation jigs.

Whilst the present invention has been described and illustrated with reference to particular embodiments, it will be appreciated by those of ordinary skill in the art that the invention lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of separating infill material of synthetic turf, the infill material comprising sand, rubber and fibres, the method comprising
combining the infill material with water to form an infill slurry, and
separating one or more of the sand, rubber and fibres from the infill slurry.

2. The method according to claim 1, wherein a hydrocyclone is used to separate the infill slurry into a fibre slurry and a sand/rubber slurry.

3. The method according to claim 2, wherein a density separator is used to separate sand and rubber from the sand/rubber slurry; and wherein said density separator is selected from the group consisting of a fluidised bed separator, a spiral separator, an upflow classifier, and a separation jig.

4. The method according to claim 3, further comprising the step of adding water to the sand/rubber slurry after it has left the hydrocyclone and before it has entered the density separator.

5. The method according to claim 2, wherein the majority of the water which enters the hydrocyclone leaves the hydrocyclone in the fibre slurry.

6. The method according to claim 1, wherein the water component of the fibre slurry is recycled for use elsewhere in the method.

7. The method according to claim 1, further comprising the step of feeding the infill material into a trash screen to separate debris from the infill material before combining the infill material with water.

8. The method according to claim 1, wherein the infill material is loaded into a hopper and the infill material is fed from the hopper to the trash screen.

9. The method according to claim 1, wherein the infill material is removed from a synthetic turf pitch prior to being combined with the water.

10. The method according to claim 9, wherein the method takes place on the site of the synthetic turf pitch.

11. An apparatus for separating sand and rubber from synthetic turf infill material comprising sand, rubber and fibres, the apparatus comprising a compartment for receiving infill material and combining the infill material with water to produce an infill slurry, and a separator configured to separate one or more of (i) sand, (ii) rubber and/or (iii) fibres from the infill slurry.

12. The apparatus according to claim 11, comprising a first separator configured to separate the infill slurry into a fibre slurry and a sand/rubber slurry and a second separator configured to separate the sand/rubber slurry into produce a sand slurry and a rubber slurry.

13. The apparatus according to claim 12, wherein the first separator is a hydrocyclone.

14. The apparatus according to claim 12, wherein the second separator is a density separator.

15. The apparatus according to claim 14, wherein the density separator is a spiral separator.

16. The apparatus according to claim 12, wherein the apparatus comprises a trash screen for removing debris from the infill material and infill material passes through the trash screen and into the compartment.

17. The apparatus according to claim 11, wherein the apparatus is provided in a single unit.

18. The apparatus according to claim 17, wherein the unit further comprises a hopper, a sand screen, a rubber screen, a pump, and/or piping.

19. The apparatus according to claim 11, wherein the apparatus is contained within the footprint of a standard 20 ft shipping container.

20. The method according to claim 1, further comprising using an apparatus having a compartment for receiving infill material and combining the infill material with water to produce an infill slurry, and a separator configured to separate one or more of (i) sand, (ii) rubber and/or (iii) fibres from the infill slurry; and
transporting said apparatus to a site of a synthetic turf surface.
